(19) United States
(12) Patent Application Publication
(10) Pub. No.: US 2024/0265824 A1
(43) Pub. Date: Aug. 8, 2024

(54) A-Z Mark in the Middle! Tracing Tool

(71) Applicant: Cynthia Jean Nawar, Terre Haute, IN (US)

(72) Inventor: Cynthia Jean Nawar, Terre Haute, IN (US)

(21) Appl. No.: 18/164,573

(22) Filed: Feb. 4, 2023

(51) Int. Cl. G09B 11/04; B43L 13/20

(52) U.S. Cl. CPC G09B 11/04; B43L 13/208

(57) ABSTRACT

The A-Z Mark in the Middle! Tracing Tool is a set of alphabet letters in uppercase, that can be used in Special Education or even with the general population, to assist in the learning of their shapes by means of tracing the lines of the letter shapes. The letters will have an indentation in which a writing utensil will be placed, and the user will use that indentation to draw the letter. With the aid of this tool the user will be more successful in identifying letters and writing them, and consequently will display proper handwriting skills.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains to the field of endeavor related to section B43L, Articles for Writing or Drawing, in the Cooperative Patent Classification system. This invention can be classified under Writing or Drawing Aid as noted in B43L 13/20. It can be classified as a Non-circular-curve-drawing instrument with stencils as noted in B43L 11/043 because some of the design of some of the letters. This invention may also pertain to Lettering Device Drawing Accessory B43L 13/004 as its purpose is defined.

In my experience as a therapist for 14 years, working with various age groups in the Special Needs & Disabilities population, I have seen many persons struggle with the fine motor skill of drawing letters, and while they succeed with assistance from I the therapist or another adult, the independence is lacking. Strong visual-motor integration skills are displayed in eye-hand coordination. Guidelines and resources are given to caregivers and families on the necessity of tracing and eye-hand coordination by the Niagra Children's Centre Occupational Therapy department.

This invention is a tracing/writing tool to be utilized with students of all ages learning the writing skill and learning the English alphabet, and most effectively but not limited to, the Special Needs population who often require adaptations to learn skills. It can be employed by anyone in the Education field, Therapists in any therapy environment, and even in the home. The importance of writing and drawing for children of any level is confirmed in the Individuals with Disabilities Education Act (IDEA) Statute and Regulations handbook.

Other materials that currently exist to assist with learning the alphabet by tracing are problematic. Tracing letters by dotted/solid lines directly onto paper does not provide any type of boundary for the writing utensil, so the student can trace the lines but, in their efforts, may extend their utensil too far past the spacing of the letter, thus canceling what was receptively learned about the letter and prolonging the acquisition of the skill. Plastic alphabet letters already exist that have been useful in teaching visual recognition of the objects, however, they do not teach how to draw the objects themselves.

All 26 letters will be made from clear, transparent material: this is to avoid confusion with other colored items that may be in the environment, and limit the variables that will be presented with this tool. All products of this same nature that exist in the market today are colored different colors, which can be helpful for children learning color recognition, though that skill is a distinct skill from the tracing/writing skill. According to an article abstract in The Journal of Genetic Psychology, children display distinct color-emotion associations. If the letter tools are colored, as most of them are today, the student/child will have an emotional response to the letter based on the color, pulling their focus away from the tracing/writing skill to be learned and towards their emotional response. For instruction of the tracing/writing skill the student/child needs to have their full attention on this. The article mentioned above can be found here: https://doi.org/10.1080/00221325.1994.9914760.

Additionally, the letters in the A-Z Mark in the Middle! Tracing Tool will all be uppercase in form, rather than lowercase. This is due to the fact that children learn to write uppercase letters before they do lowercase, which, according to the article Dimensionality and Reliability of Letter Writing in 3- to 5-Year-Old Preschool Children published in The National Library of Medicine, may be because writing lowercase letters are more difficult that uppercase. (Puranik C S, Petscher Y, Lonigan C J. Dimensionality and Reliability of Letter Writing in 3- to 5-Year-Old Preschool Children. Learn Individ Differ. 2013 December; 28:133-141. doi: 10.1016/j.lindif.2012.06.011. PMID: 26346443; PMCID: PMC4557880).

### BRIEF SUMMARY OF THE INVENTION

The A-Z Mark in the Middle! Tracing Tool is a set of alphabet letters in uppercase, that can be used to assist in the teaching of letters and the learning of their shapes by means of tracing the lines of the letterform strokes while simultaneously feeling the shape of the letter. This adaptive equipment can be most helpful in the education of those persons with Special Needs or those with learning deficits who need focused assistance in fine motor skills and motor memory.

All 26 letters will be made from transparent material. The letters of the A-Z Mark in the Middle! tool will be clear in appearance to ensure the most possible amount of attention may be placed on the skill.

Visual-motor integration will be better addressed with the use of this adaptive equipment, as the user sees the shape of the letter and feels the shape as they guide their utensil (i.e. pen, pencil, permanent marker, dry-erase marker, crayon, or colored pencil) within the provided boundaries of the letter's ‘channels’. The ‘channels’ will conform to the shape of the letter, and be present within each letterform stroke or curve. The ‘channels’ will be wide enough to accommodate most writing and drawing utensils, at a width of ⅛″. The number of ‘channels’ present will be determined by the shape of the letter and how many strokes or curves make up each letterform.

This adaptive writing equipment will not only teach letter recognition, but it will also aid in teaching the actual shapes of the letters for writing purposes. The user will place their utensil (examples above) in one of the ‘channels’ and mark on the writing surface, beginning the tracing of the letter by following the ‘channel’ boundaries with the utensil. Once all ‘channels’ within the letterform strokes have been traced through the user has completed the tracing of the letter, and their drawing on the writing surface underneath is visible; an even clearer view can be seen by removing the letterform off of the surface.

In each alphabet set, there will be provided uppercase letters. The letters will be easy to clean and durable to withstand rough handling and constant use. Each letter will be magnetic for use on magnetic surfaces.

### BRIEF DESCRIPTION OF SEVERAL VIEWS OF THE DRAWINGS

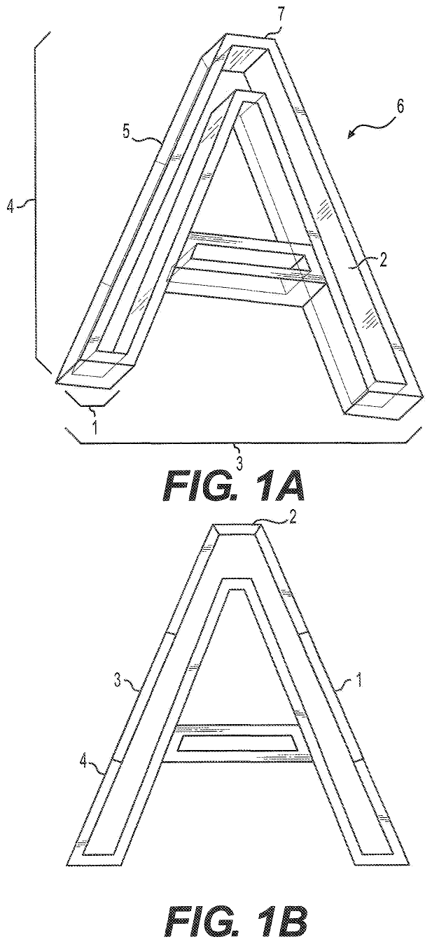

FIG. 1A Letter A, Front view
1 Letterform stroke, ⅜″ W
2 Tracing channel, ⅛″ W
3 2″ W
4 2″ H
5¼″ D
6 Material: clear, transparent plastic
7 Letterform curve, ⅜″ W

FIG. 1B Letter A, Backside view
1 Magnet on stroke, ⅛″ W× 2/8″ L
2 Magnet on curve, ⅛″ W×⅛″ L
3 Magnet, 3 mm thick
4 Adhesive for magnets

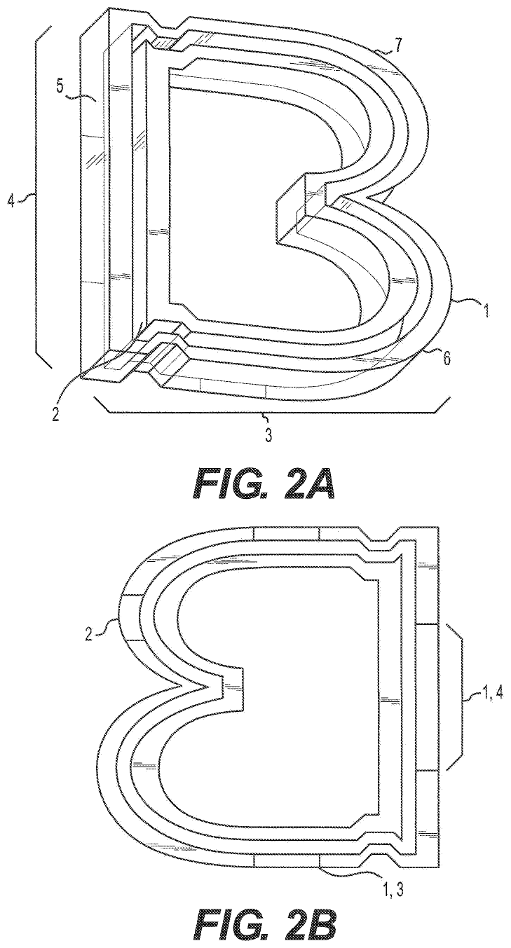

FIG. 2A Letter B, Front view
1 Letterform stroke, ⅜″ W
2 Tracing channel, ⅛″ W
3 2″ W
4 2″ H
5 ¼″ D
6 Material: clear, transparent plastic
7 Letterform curve, ⅜″ W

FIG. 2B Letter B, Backside view
1 Magnet on stroke, ⅛″ W× 2/8″ L
2 Magnet on curve, ⅛″ W×⅛″ L
3 Magnet, 3 mm thick
4 Adhesive for magnets

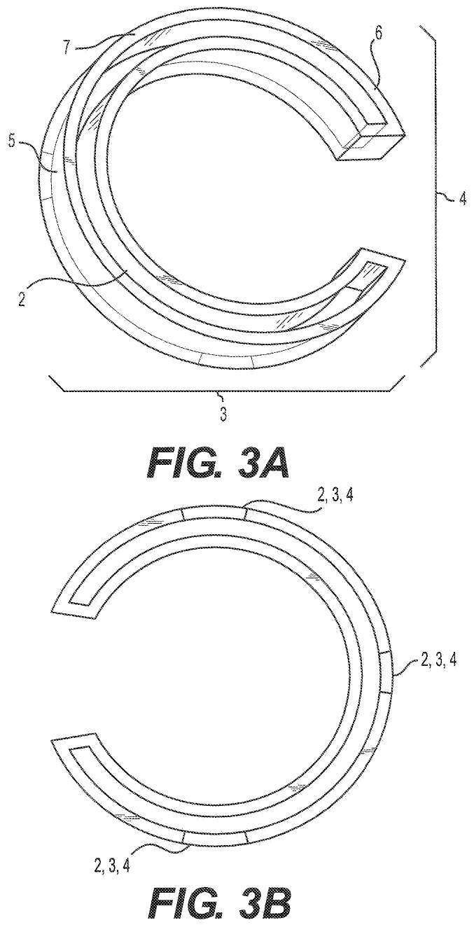

FIG. 3A Letter C, Front view
2 Tracing channel, ⅛″ W
3 2″ W
4 2″ H
5 ¼″ D
6 Material: clear, transparent plastic
7 Letterform curve, ⅜″ W

FIG. 3B Letter C, Backside view
2 Magnet on curve, 1/8″ W×⅛″ L
3 Magnet, 3 mm thick
4 Adhesive for magnets

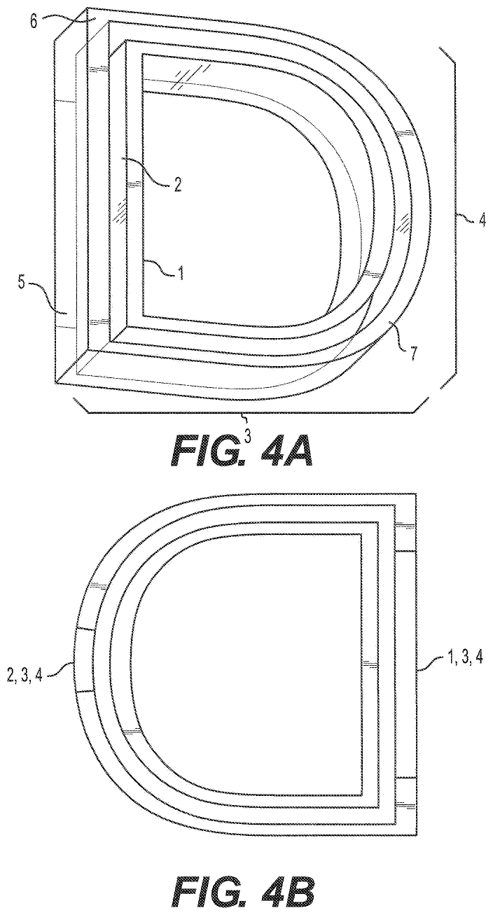

FIG. 4A Letter D, Front view
1 Letterform stroke, ⅜″ W
2 Tracing channel, ⅛″ W
3 2″ W
4 2″ H
5 ¼″ D
6 Material: clear, transparent plastic
7 Letterform curve, ⅜″ W

FIG. 4B Letter D, Backside view
1 Magnet on stroke, ⅛″ W× 2/8″ L
2 Magnet on curve, ⅛″ W×⅛″ L
3 Magnet, 3 mm thick
4 Adhesive for magnets

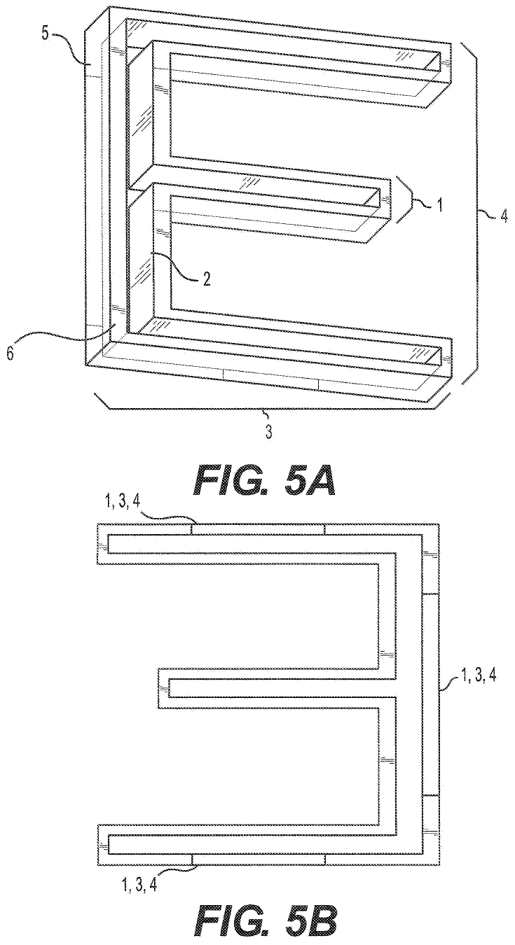

FIG. 5A Letter E, Front view
1 Letterform stroke, ⅜″ W
2 Tracing channel, ⅛″ W
3 2″ W
4 2″ H
5 ¼″ D
6 Material: clear, transparent plastic

FIG. 5B Letter E, Backside view
1 Magnet on stroke, ⅛″ W× 2/8″ L
3 Magnet, 3 mm thick
4 Adhesive for magnets

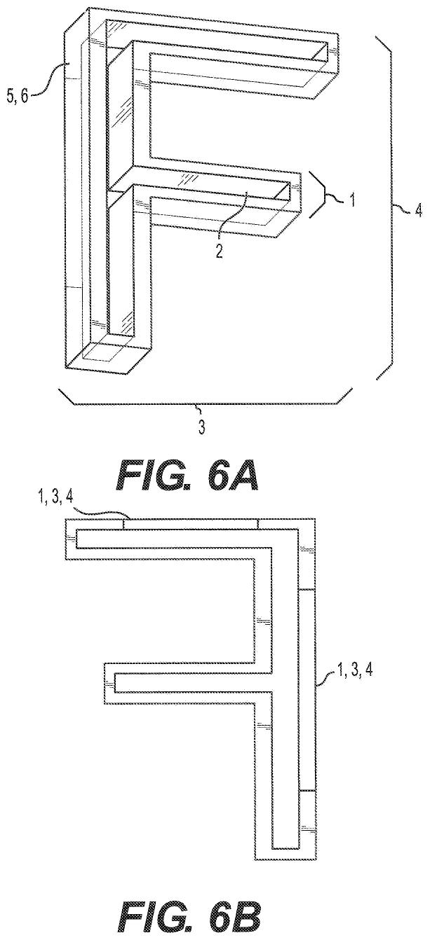

FIG. 6A Letter F, Front view
1 Letterform stroke, ⅜″ W
2 Tracing channel, ⅛″ W
3 2″ W
4 2″ H
5 ¼″ D
6 Material: clear, transparent plastic

FIG. 6B Letter F, Backside view
1 Magnet on stroke, ⅛″ W× 2/8″ L
3 Magnet, 3 mm thick
4 Adhesive for magnets

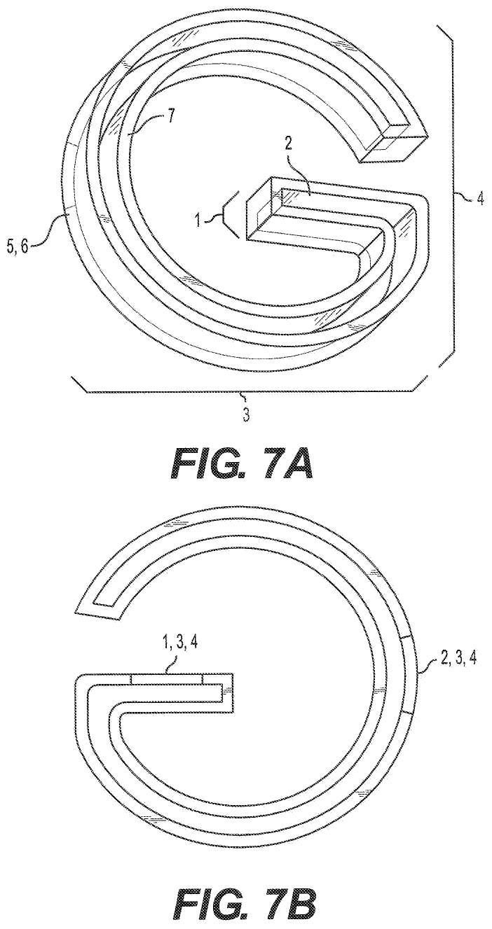

FIG. 7A Letter G, Front view
1 Letterform stroke, ⅜″ W
2 Tracing channel, ⅛″ W
3 2″ W
4 2″ H
5 ¼″ D
6 Material: clear, transparent plastic
7 Letterform curve, ⅜″ W

FIG. 7B Letter G, Backside view
1 Magnet on stroke, ⅛″ W× 2/8″ L
2 Magnet on curve, ⅛″ W×⅛″ L
3 Magnet, 3 mm thick
4 Adhesive for magnets

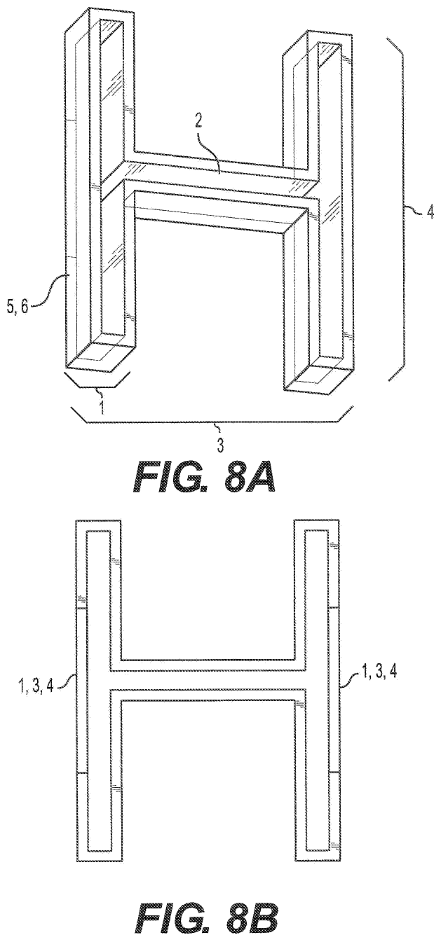

FIG. 8A Letter H, Front view
1 Letterform stroke, ⅜″ W
2 Tracing channel, ⅛″ W
3 2″ W
4 2″ H
5 ¼″ D
6 Material: clear, transparent plastic

FIG. 8B Letter H, Backside view
1 Magnet on stroke, ⅛″ W× 2/8″ L
3 Magnet, 3 mm thick
4 Adhesive for magnets

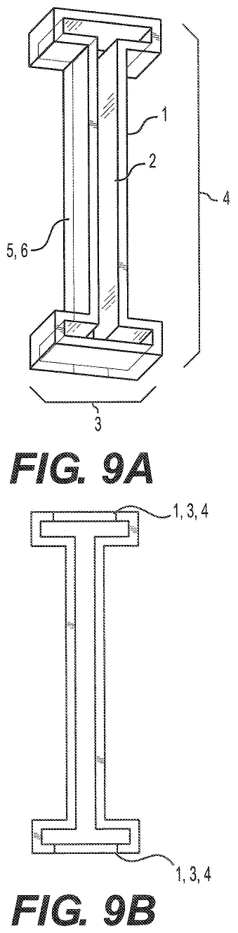

FIG. 9A Letter I, Front view
1 Letterform, ⅜″ W
2 Tracing channel, ⅛″ W
3 2″ W
4 2″ H
5 ¼″ D
6 Material: clear, transparent plastic

FIG. 9B Letter I, Backside view
1 Magnet on stroke, ⅛″ W× 2/8″ L
3 Magnet, 3 mm thick
4 Adhesive for magnets

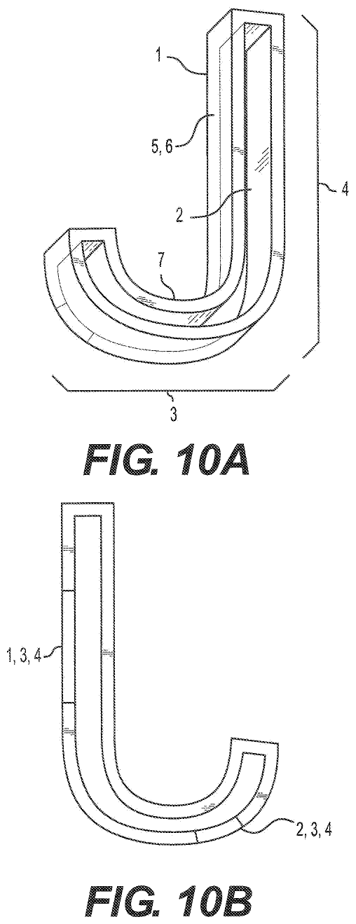

FIG. 10A Letter J, Front view
1 Letterform stroke, ⅜″ W
2 Tracing channel, ⅛″ W
3 2″ W
4 2″ H
5 ¼″ D
6 Material: clear, transparent plastic
7 Letterform curve, ⅜″ W

FIG. 10B Letter J, Backside view
1 Magnet on stroke, ⅛″ W× 2/8″ L
2 Magnet on curve, ⅛″ W×⅛″ L
3 Magnet, 3 mm thick
4 Adhesive for magnets

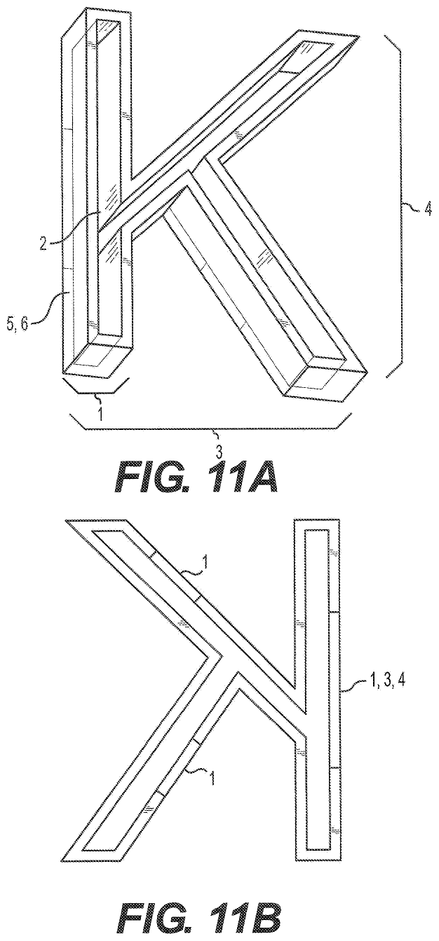

FIG. 11A Letter K, Front view
1 Letterform stroke, ⅜″ W
2 Tracing channel, ⅛″ W
3 2″ W
4 2″ H
5 ¼″ D
6 Material: clear, transparent plastic

FIG. 11B Letter K, Backside view
1 Magnet on stroke, ⅛″ W× 2/8″ L
3 Magnet, 3 mm thick
4 Adhesive for magnets

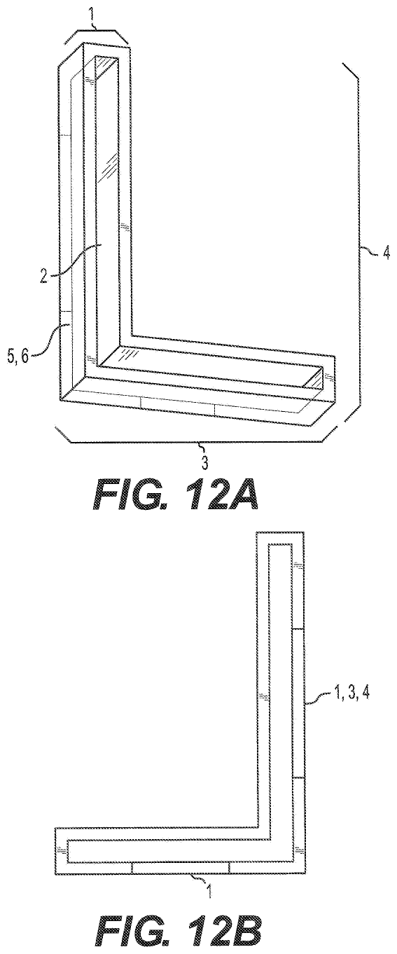

FIG. 12A Letter L, Front view
1 Letterform stroke, ⅜″ W
2 Tracing channel, ⅛″ W
3 2″ W
4 2″ H
5 ¼″ D
6 Material: clear, transparent plastic

FIG. 12B Letter L, Backside view
1 Magnet on stroke, ⅛″ W× 2/8″ L
3 Magnet, 3 mm thick
4 Adhesive for magnets

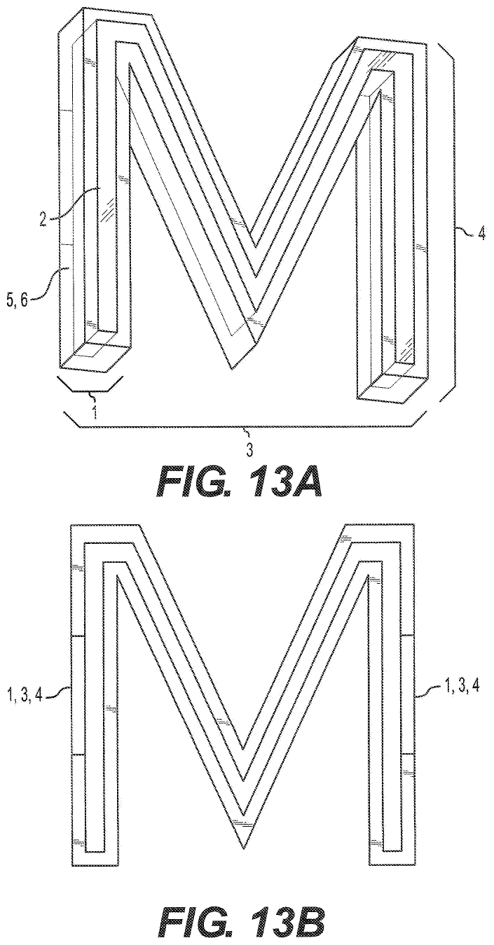

FIG. 13A Letter M, Front view
1 Letterform stroke ⅜″ W
2 Tracing channel, ⅛″ W
3 2″ W
4 2″ H
5 ¼″ D
6 Material: clear, transparent plastic

FIG. 13B Letter M, Backside view
1 Magnet on stroke, ⅛″ W× 2/8″ L
3 Magnet, 3 mm thick
4 Adhesive for magnets

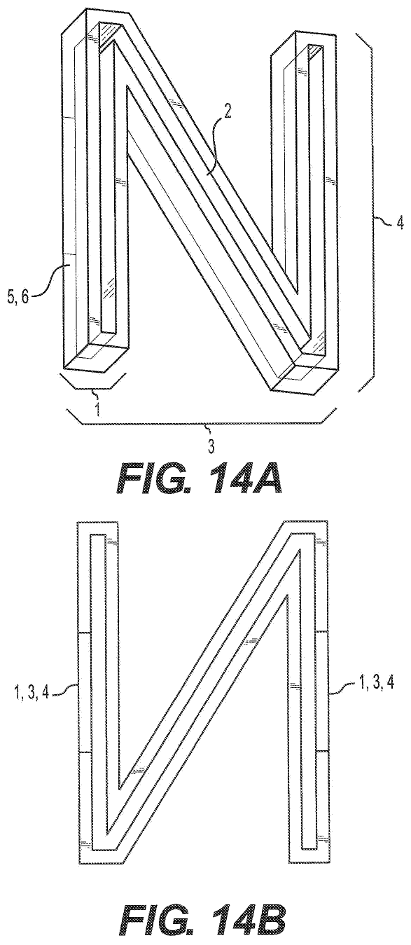

FIG. 14A Letter N, Front view
1 Letterform stroke, ⅜″ W
2 Tracing channel, ⅛″ W
3 2″ W
4 2″ H
5 ¼″ D
6 Material: clear, transparent plastic

FIG. 14B Letter N, Backside view
1 Magnet on stroke, ⅛″ W× 2/8″ L
3 Magnet, 3 mm thick
4 Adhesive for magnets

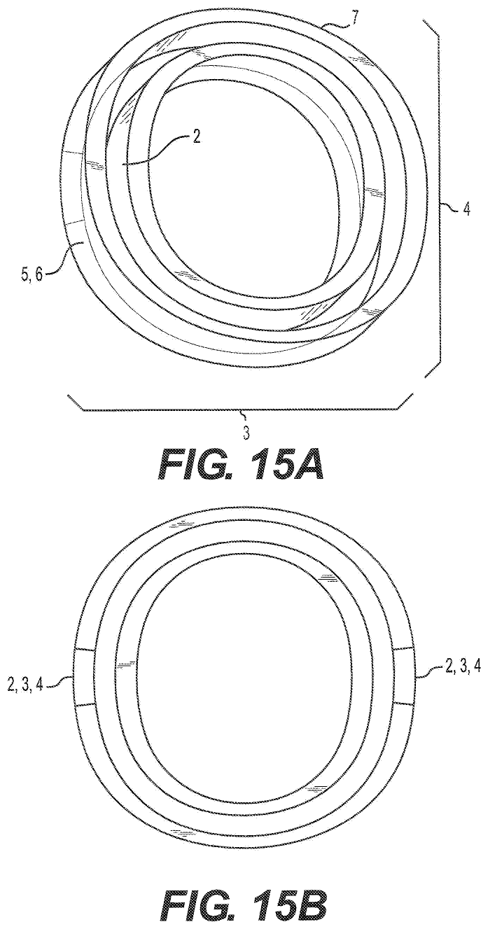

FIG. 15A Letter O, Front view
2 Tracing channel, ⅛″ W
3 2″ W
4 2″ H
5 ¼″ D
6 Material: clear, transparent plastic
7 Letterform curve, ⅜″ W

FIG. 15B Letter O, Backside view
2 Magnet on curve, ⅛″ W×⅛″ L
3 Magnet, 3 mm thick
4 Adhesive for magnets

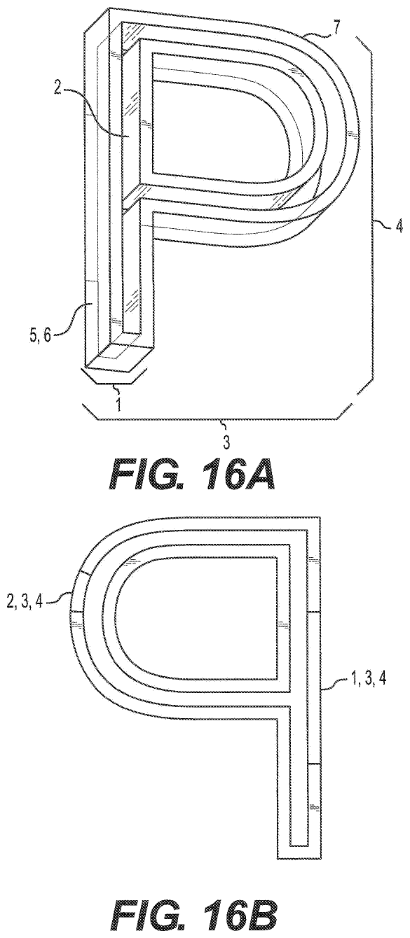

FIG. 16A Letter P, Front view
1 Letterform stroke, ⅜″ W
2 Tracing channel, ⅛″ W
3 2″ W
4 2″ H
5 ¼″ D
6 Material: clear, transparent plastic
7 Letterform curve, ⅜″ W

FIG. 16B Letter P, Backside view
1 Magnet on stroke, ⅛″ W× 2/8″ L
2 Magnet on curve, ⅛″ W×⅛″ L
3 Magnet, 3 mm thick
4 Adhesive for magnets

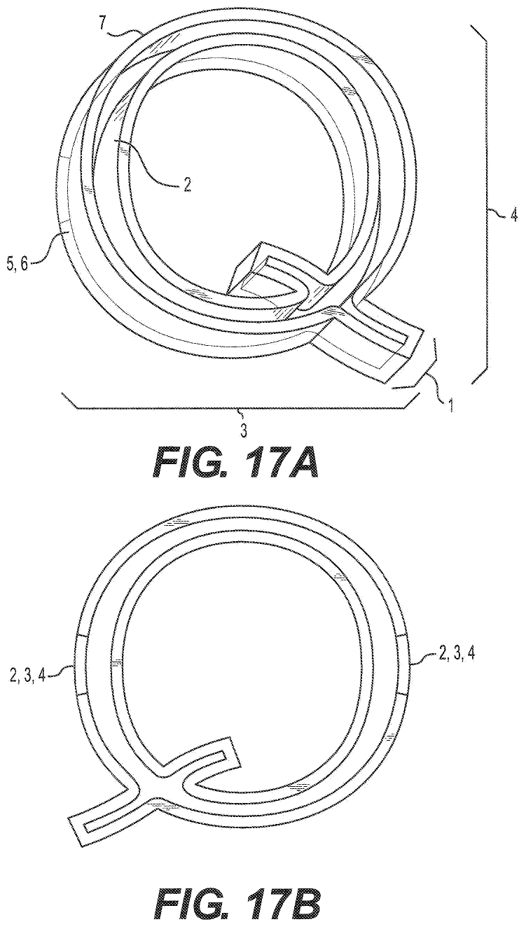

FIG. 17A Letter Q, Front view
1 Letterform stroke, ⅜″ W
2 Tracing channel, ⅛″ W
3 2″ W
4 2″ H
5 ¼″ D
6 Material: clear, transparent plastic
7 Letterform curve, ⅜″ W

FIG. 17B Letter Q, Backside view
2 Magnet on curve, ⅛″ W×⅛″ L
3 Magnet, 3 mm thick
4 Adhesive for magnets

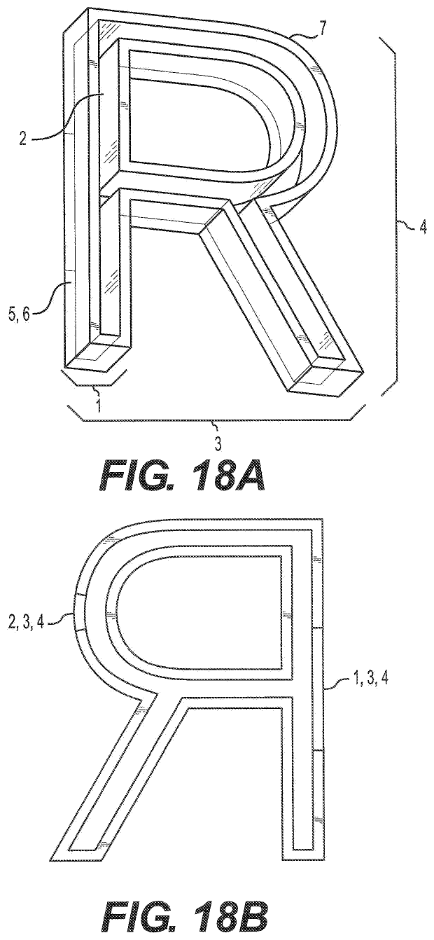

FIG. 18A Letter R, Front view
1 Letterform stroke, ⅜″ W
2 Tracing channel, ⅛″ W
3 2″ W
4 2″ H
5 ¼″ D
6 Material: clear, transparent plastic
7 Letterform curve, ⅜″ W

FIG. 18B Letter R, Backside view
1 Magnet on stroke, ⅛″ W× 2/8″ L
2 Magnet on curve, ⅛″ W×⅛″ L
3 Magnet, 3 mm thick
4 Adhesive for magnets

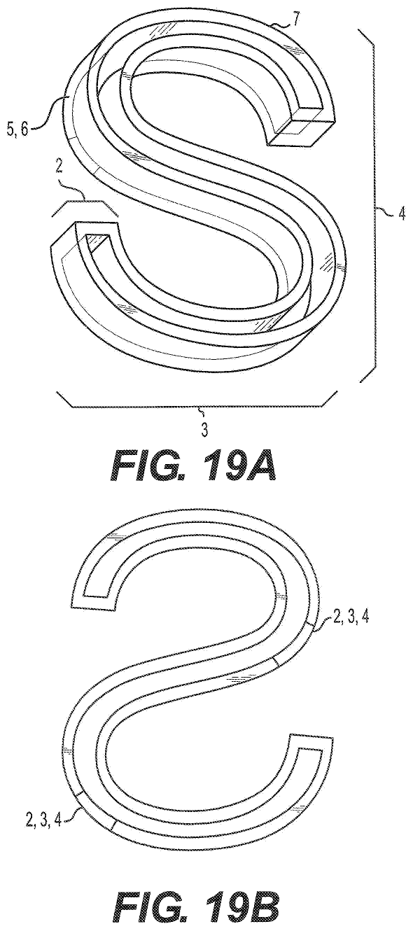

FIG. 19A Letter S, Front view
2 Tracing channel, ⅛″ W
3 2″ W
4 2″ H
5 ¼″ D
6 Material: clear, transparent plastic
7 Letterform curve, ⅜″ W

FIG. 19B Letter S, Backside view
2 Magnet on curve, ⅛″ W×⅛″ L
3 Magnet, 3 mm thick
4 Adhesive for magnets

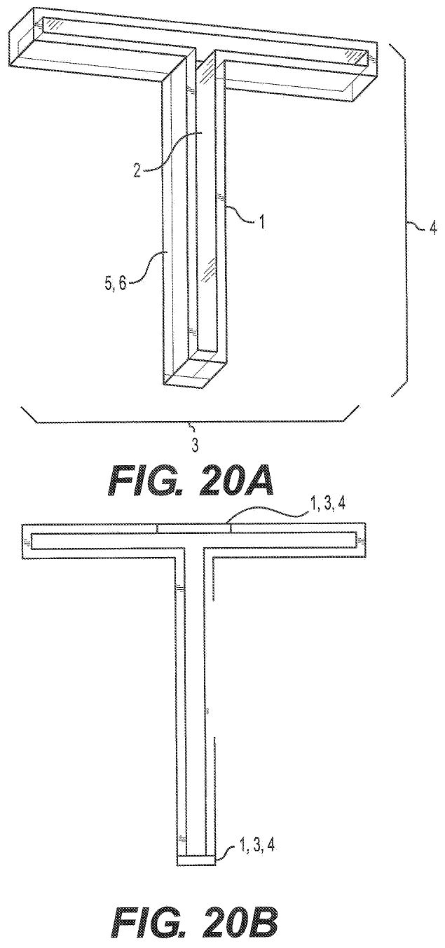

FIG. 20A Letter T, Front view
1 Letterform stroke, ⅜″ W
2 Tracing channel, ⅛″ W
3 2″ W
4 2″ H
5 ¼″ D
6 Material: clear, transparent plastic

FIG. 20B Letter T, Backside view
1 Magnet on stroke, ⅛″ W× 2/8″ L
3 Magnet, 3 mm thick
4 Adhesive for magnets

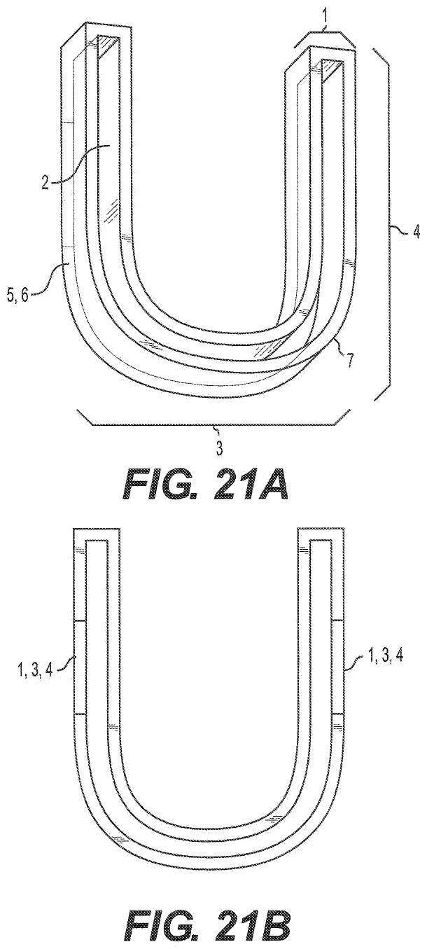

FIG. 21A Letter U, Front view
1 Letterform stroke, ⅜″ W
2 Tracing channel, ⅛″ W
3 2″ W
4 2″ H
5 ¼″ D
6 Material: clear, transparent plastic
7 Letterform curve, ⅜″ W

FIG. 21B Letter U, Backside view
1 Magnet on stroke, ⅛″ W× 2/8″ L
3 Magnet, 3 mm thick
4 Adhesive for magnets

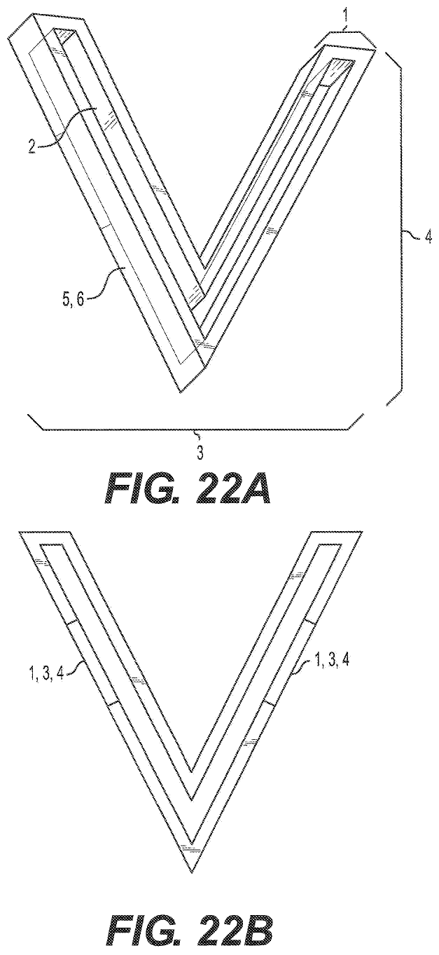

FIG. 22A Letter V, Front view
1 Letterform stroke, ⅜″ W
2 Tracing channel, ⅛″ W
3 2″ W
4 2″ H
5¼″ D
6 Material: clear, transparent plastic

FIG. 22B Letter V, Backside view
1 Magnet on stroke, ⅛″ W× 2/8″ L
3 Magnet, 3 mm thick
4 Adhesive for magnets

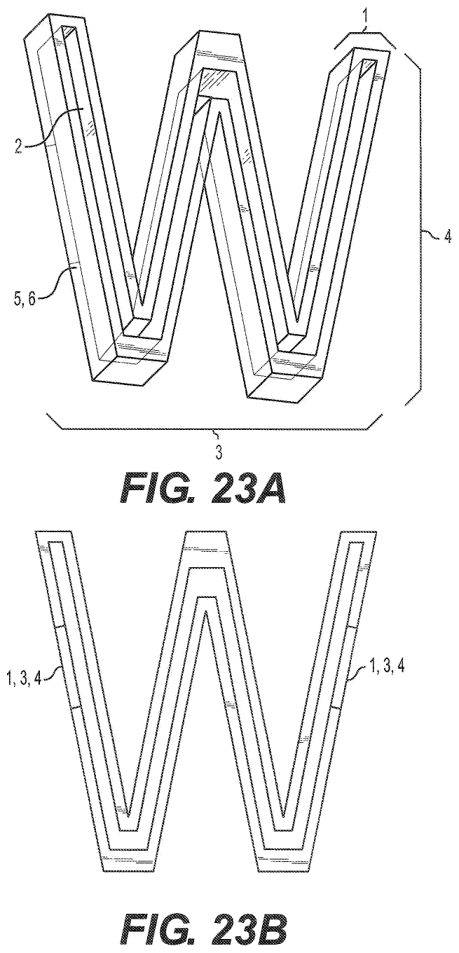

FIG. 23A Letter W, Front view
1 Letterform stroke, ⅜″ W
2 Tracing channel, ⅛″ W
3 2″ W
4 2″ H
5 ¼″ D
6 Material: clear, transparent plastic

FIG. 23B Letter W, Backside view
1 Magnet on stroke, ⅛″ W× 2/8″ L
3 Magnet, 3 mm thick
4 Adhesive for magnets

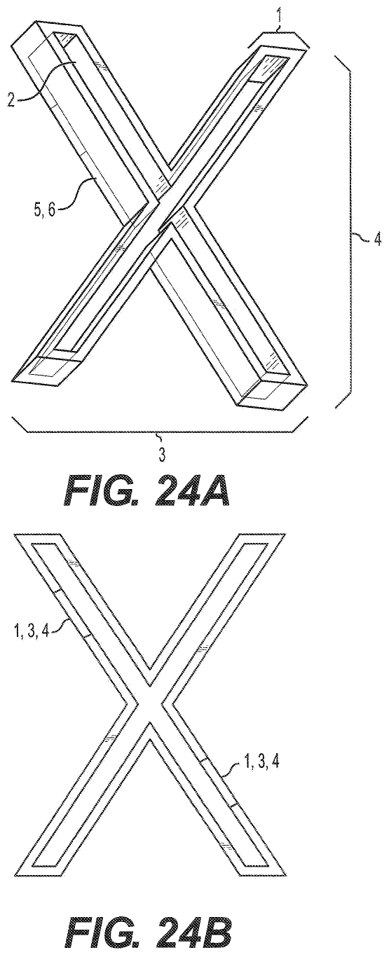

FIG. 24A Letter X, Front view
1 Letterform stroke, ⅜″ W
2 Tracing channel, ⅛″ W
3 2″ W
4 2″ H
5¼″ D
6 Material: clear, transparent plastic

FIG. 24B Letter X, Backside view
1 Magnet on stroke, ⅛″ W× 2/8″ L
3 Magnet, 3 mm thick
4 Adhesive for magnets

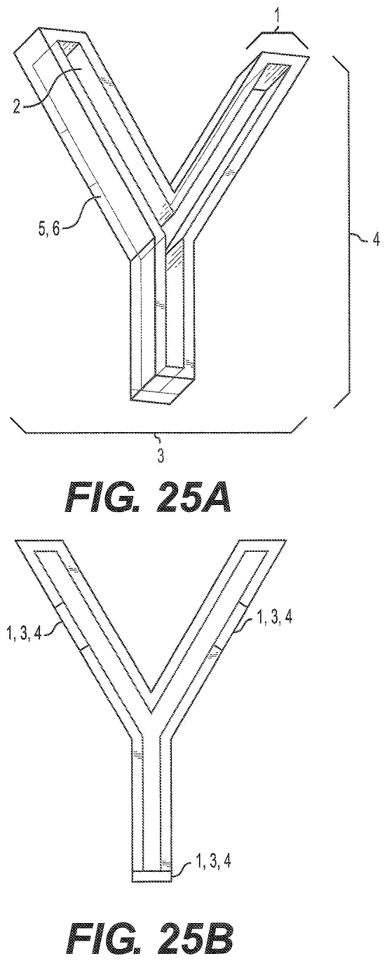

FIG. 25A Letter Y, Front view
1 Letterform stroke, ⅜″ W
2 Tracing channel, ⅛″ W
3 2″ W
4 2″ H
5 ¼″ D
6 Material: clear, transparent plastic

FIG. 25B Letter Y, Backside view
1 Magnet on stroke, ⅛″ W× 2/8″ L
3 Magnet, 3 mm thick
4 Adhesive for magnets

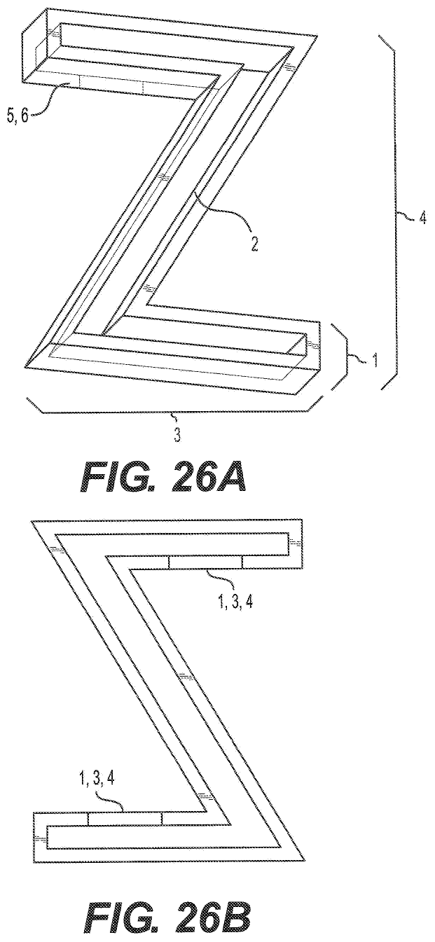

FIG. 26A Letter Z, Front view
1 Letterform stroke, ⅜″ W
2 Tracing channel, ⅛″ W
3 2″ W
4 2″ H
5 ¼″ D
6 Material: clear, transparent plastic

FIG. 26B Letter Z, Backside view
1 Magnet on stroke, ⅛″ W× 2/8″ L
3 Magnet, 3 mm thick
4 Adhesive for magnets

### DETAILED DESCRIPTION

### Process:

The user will place the letter on a writing surface. They will use writing utensils to place inside the ‘channel’ of the letter. They will follow the ‘channel’ with their utensil throughout the letter until they have drawn all the ‘channels’. They can lift the letter off the surface to see the lines drawn for that particular letter in the exact form of the letter. They will learn the exact form of the letter and how strokes/curves create each letterform.

### Composition of Matter:

Each letter in the set of the A-Z Mark in the Middle! tool will be composed of clear, non-toxic plastic for easy cleaning and transparency to the lines drawn underneath.

Each letterform will be uppercase. Each letter's specifications will consist of being ¼-inch thick, 2 inches wide from the widest point on the left to the widest point in the right, and 2 inches in height from lowest point at the bottom to the tallest point at the top. The front views of the drawings for each letter reference these specifications.

Every stroke and curve of each letterform will be ⅜-inch wide. This will allow for the ⅛-inch channel to be housed in between material of ⅛-inch width on either side of the channel. The channel in each letterform will be ⅛-inch wide. The number of channels for each letter will be dependent on the shape of each letter. The channels will pass through each stroke or curve of each letterform, thus the number of channels will differ for each letterform. The front views of the drawings for each letter reference these specifications.

Magnets will be approximately 3 mm in thickness and will be mounted to the reverse side of each letterform attached by non-toxic adhesive, to the backside parts of the structure. The number of magnet pieces used will depend on the strokes and curves that create each letterform: a piece of magnet can be placed near the top, bottom, left, or right sides of the structure. The amount of magnetic material used for a curve will be ⅛ inch in width and ⅛-inch in length; a ⅛-inch width piece and a 2/8-inch length piece of magnet will be used on strokes. The magnets will not necessarily be flush with the structure's backside, rather they may protrude outward from the backside surface. However, the magnetic material pieces on each letterform will be flush with each other, resting on the same plane, ensuring the letter will sit flat against the surface when in use. The backside views of the drawings for each letter indicate the magnets.

What is claimed is:

1. A tracing/writing tool comprising:
a set of 26 English alphabet letters;
a material of nontoxic plastic fabricated for said letters;
a ‘channel’ embedded within said nontoxic plastic of said letters; and
a magnet component for each said letter.

2. A tracing/writing tool as in claim 1, wherein said letters will be uppercase in form.

3. A tracing/writing tool as in claim 1, wherein said nontoxic plastic fabricated for said letters will be clear and transparent.

4. A tracing/writing tool as in claim 1, wherein said ‘channel’ will travel each stroke of each said letter.

5. A tracing/writing tool as in claim 1, wherein said magnet component will be for use on magnetic and nonmagnetic surfaces for said letters.

6. A tracing/writing tool as in claim 2, wherein said letters will be ¼ inch in thickness, 2 inches in width and height.

7. A tracing/writing tool as in claim 4, wherein said ‘channels’ will be ⅛ inch in width.

8. A tracing/writing tool as in claim 5, wherein said magnet components can be placed on left, right, top, and bottom sides, depending on shape of said letterforms.

9. A tracing/writing tool as in claim 5, wherein said magnet components will have the dimensions of ⅛-inch×⅛-inch for curves, ⅛-inch× 2/8-inch for strokes for said letters.

10. A tracing/writing tool as in claim 5, wherein said magnet components will be 3 mm in thickness.

11. A tracing/writing tool as in claim 9, further comprising nontoxic adhesive mounted to said magnet components.
